(19) United States
(12) Patent Application Publication
(10) Pub. No.: US 2006/0020444 A1
(43) Pub. Date: Jan. 26, 2006

(54) Ontology based medical system for data capture and knowledge representation

(76) Inventors: Leo E. Cousineau, Edgewater, MD (US); Sandra A. Allen, Silver Spring, MD (US); Ravindra Robert Brewster, Arlington, VA (US); Kathryn Ann Lesh, Tacoma Park, MD (US); Peter L. Cherpes, Haymarket, VA (US); Harry Young, Rockvale, TN (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/034,962

(22) Filed: Jan. 14, 2005

Related U.S. Application Data
(60) Provisional application No. 60/591,229, filed on Jul. 26, 2004.
(60) Provisional application No. 60/624,715, filed on Nov. 3, 2004.

(51) Int. Cl. G06F 17/20

(52) U.S. Cl. 704/1

(57) ABSTRACT

A healthcare related system is disclosed in which non-standard input data is corrected in a syntax processing block with reference to one or more healthcare lexicons, and a resulting corrected data file is thereafter used by an ontology processing block to reference an ontology and generate a standardized output.

This application claims the benefit of U.S. Provisional Application No. 60/591,229 filed Jul. 26, 2004 and U.S. Provisional Application No. 60/624,715 filed Nov. 3, 2004.

### BACKGROUND OF THE INVENTION

1. Field of the Invention

The invention relates generally to data capture and standardized healthcare-related knowledge representation. More specifically, the invention relates to an ontology-based system capable of transforming non-standard input data related to a patient evaluation into a standardized output.

2. Description of the Related Art

There continues to be an explosion of information in nearly every area of human endeavor. Two major problems confronting information system designers are (1) how to efficiently capture and store this wealth of information in digital media, and, (2) how to organize and/or communicate the information in such a way that it is useful and meaningful to human users and other digital systems and devices.

A great deal of research has focused on developing effective automated methods for capturing and encoding data from a wide range of sources such as paper documents, photographs, digital images, audio data, and so forth. Some of the technologies resulting from this research include voice recognition systems, optical character recognition systems, and image processing systems, to name but a few. Many of these technologies have reached the point where they can reliably recognize and extract data primitives such as words, sentences, shapes, or even human faces from raw, unstructured input data.

Still other research has focused on taking data which has already been captured and encoded, and representing the data in such a way that it is easily interpreted by various agents, such as computer users, search engines, routers, spread sheet applications, statistical engines, etc. Conventional approaches to solving this problem include, for example, indexing schemes which identify or highlight important features in stored data. For example, an image containing a green triangle may be digitally tagged with an identifier of “green triangle” so that a search engine seeking to locate images containing a green triangle can do so by simply examining image tags. Likewise, textual data can be tagged with identifiers, which may include, for example, key words selected from text data.

More advanced conventional approaches to this problem, however, focus on providing a formal representation of the input data's semantic content, i.e. some indication of the input data's meaning. Providing a formal representation of the input data's semantic content is beneficial to agents receiving and processing the data because it allows them to reason, (e.g., calculate, make determinations, or construct higher order data structures) in relation to the input data using conceptual or higher order terms. Hence, an accurate and appropriate formal representation of the input data enables agents to make well informed high-level decisions.

A formal representation of input data's semantic content is provided, for example, by an ontology. In this context, an ontology is a structured representation of agreements about a set of concepts that characterize the data. The content, structure, and implementation of an ontology can vary widely. However, an ontology generally comprises a plurality of related concepts linked together in a hierarchical manner (e.g., using “IS_A” relationships) to form a taxonomy, and thereafter enriched with additional higher-order relationships between taxonomy concepts to enable the expression of specific knowledge. The concept “higher-order relationships” should be broadly construed to cover all relationships, constraints, and rules having greater complexity than a simple single relationship, such as “IS_A”.

An ontology is defined in relation to a particular domain. For example, the University of Washington School of Medicine has defined a Foundational Model of Anatomy in the domain of life science which provides a framework for describing various properties, behaviors, and relationships of components and concepts relative to the human body. (See, http://sig.biostr.washington.edu/projects/fm/AboutFM.html). An ontology is defined with respect to a particular domain for various reasons. One reason is so the ontology can represent a very specific set of interrelated concepts. Another reason is so concepts which are denoted by similar terms in different domains can be represented unambiguously.

An ontology is a particularly desirable way of representing knowledge in computer system applications because it allows for transparent communication between different hardware platforms and software applications. In other words, since an ontology provides an explicit formal representation of the semantic content of data, rather than relying on ad hoc techniques such as tagging, indexing, or hashing, the data represented using an ontology may be readily transferred between different systems.

Due to the high level of interest in developing electronic health records (EHR) in recent years, a significant amount of research relative to data capture and knowledge representation has focused on how to create EHRs by automatically capturing and representing information provided by healthcare providers relative to patient visits or encounters. The generation of EHRs using an automated system would be a great benefit to the healthcare providers because it would significantly reduce the time that physicians and other healthcare providers spend filling out paperwork. It would also facilitate convenient downstream processing such as automated patient billing procedures.

A number of approaches for assimilating and/or representing information related to the health profession have been suggested. U.S. Pat. No. 6,304,848 describes a system that receives voice input data, extracts key-terms from the voice input data using a voice recognition system and a template based key-term identifier, and searches for matching key-terms in a database representing pre-defined medical conditions, diagnoses, and treatments. The database has a hierarchically structured tree configuration wherein primary medical terms are linked to secondary medical terms and so forth.

U.S. Patent Application Publication No. 2003/0105638 describes a system that receives structured input data and non-structured input data and processes the non-structured input data in light of the structured input data in order to produce structured output data. The structured input data takes the form of answers to a patient questionnaire or some other set of categorical facts. It is primarily used to determine the domain of the non-structured input data. The non-structured input data is voice input data which the system captures using a voice recognition system. The system uses statistically derived criteria based on a body of literature pertaining to a particular knowledge domain to determine semantic relationships for words in the same sentence. Once semantic relationships for words in the same sentence are determined, each sentence is then labeled with a logical identifier.

In the article “A voice-enabled, structured medical reporting system”, Rosenthal et al., Journal of American Medical Information Association, 4:436-41 (1997), a system is suggested which accepts unstructured voice-input data and thereafter forms a structured, searchable report by appending SGML (Standard Generalized Markup Language) tags to key words and phrases extracted from the input data.

Similarly, in “Automatic concept extraction from spoken medical reports,” Happe et al., International Journal of Medical Informatics, 70, 255-63 (2003) voice input data is captured and then subjected to indexing using a taxonomical hierarchy to produce output data susceptible to subsequent searching.

In the above approaches, as well as many other conventional systems integrating data capture and knowledge representation, the various components forming the system are highly interdependent. That is, the system's overall ability to accurately capture data influences the system's ability to represent the semantic content of the data. For example, where a voice recognition system hears the wrong word, the system is unlikely to deduce a correct meaning or properly analyze the semantic content of the voice input data. Likewise, the system's ability to accurately represent the semantic content of the data influences the system's ability to accurately capture the data. For example, where a voice recognition system is listening for the wrong types of words (i.e. is directed to a wrong domain), the system is likely to misinterpret the input data. Conventionally, since the system components are interdependent, it is inappropriate to simply combine some component performing data capture with some other component performing knowledge representation without further specifying a certain degree of cooperative relationship between the components. Hence, respective conventional systems tend to be quite narrow in their application and are ill-adapted to domain evolution or cross-domain interoperability.

Several additional shortcomings are noted in relation to conventional systems performing data capture and knowledge representation. First, such systems only represent knowledge in a restricted sense. For example, the system corresponding to U.S. Pat. No. 6,304,848 correlates key words to putative medical conditions, diagnoses, and treatments, but fails to provide the richness of knowledge representation afforded by a true ontology. As a result, information output by the system is of limited utility to downstream automated processing engines. Similarly, the system corresponding to U.S. Patent Application Publication No. 2003/0105638 outputs sentence level semantic information, which is also of limited utility to downstream processing engines. Sentence level semantic information amounts to a number of local snapshots of the input data, none of which may be significantly descriptive in and of itself. Furthermore, where a downstream process is required to assemble the local snapshots into a global conceptual picture, it is valuable for the downstream process to be have access to the original input data so that it can validate its conclusions.

Another related shortcoming noted in conventional systems is the unidirectional flow of information. In other words, there are no feedback mechanisms or sanity checks making sure that the data captured actually makes sense. For example, where the system mistakenly captures a word, it can't go back and correct itself once it has a better context for examining the word.

What is needed, therefore, is a system capable of receiving unstructured (hereafter, “non-standard”) input data, encoding the data in an appropriate format, and providing a rich and accurate representation of the semantic content of the input data.

### SUMMARY OF THE INVENTION

The invention provides in one embodiment a system comprising a syntax processing block and an ontology processing block, where the syntax processing block is associated with a healthcare lexicon and adapted to receive non-standard input data and generate a corrected data file with reference to the healthcare lexicon. The ontology processing block is adapted to receive the corrected data file and generate a standardized output by referencing an ontology in relation to the corrected data file.

The non-standard input data may include at least one of voice, handwriting, text, image data, and an electronic file, and the syntax processing block may include at least one of a voice recognition application, a forms recognition application, an image recognition application, and a file parsing application, any one of which may access the healthcare lexicon.

In a related aspect, the syntax processing block comprises a capture block wirelessly (or wired) connected to a staging block. For example, the capture block may include a wireless microphone generating a voice transcript signal, and the staging block may include a digital logic platform receiving the voice transcript signal and generating the corrected data file in response to the voice transcript signal with reference to the healthcare lexicon. The digital logic platform may take many forms, including but not limited to a Personal Computer (PC), a tablet PC, a laptop PC, or a Personal Digital Assistant (PDA).

In one embodiment, the digital logic platform comprises memory and computational logic adapted to run a capture application enabling receipt of the voice transcript signal and generation of a voice data file from the voice transcript signal, a syntax application generating the corrected data file from the voice data file with reference to the healthcare lexicon, and/or an interface application enabling a data communication link between the syntax processing block and the ontology processing block.

The data communication link connecting the syntax processing block and the ontology processing block may be comprised of one or more of the following: a Wireless Local Area Network (WLAN), a Wireless Metropolitan Area Network (WMAN), an ad-hoc wireless network, a hardwired Local Area Network (LAN), or an Ethernet connected network.

In a another embodiment, the system comprises a syntax processing block including a wireless microphone system which receives non-standard voice input data from a user and generates a voice transcript signal in response to the non-standard voice input data and a digital logic platform which wirelessly receives the voice transcript signal and generates a corrected data file with reference to one or more healthcare lexicons. The system further comprises an ontology processing block which receives the corrected data file from the syntax processing block via a data communication link and generates a standardized output in response to the corrected data file.

The digital logic platform in one embodiment comprises memory and computational logic adapted to run a syntax application generating the corrected data file from the voice data file with reference to the one or more healthcare lexicons. The syntax application may further include a criteria-correction subroutine correcting the voice data file in accordance with a criteria defining content for the corrected data file. In a more specific embodiment of the syntax application, the criteria-correction subroutine implements a voice activated, control grammar application directing the receipt of voice input data and providing feedback to the user in relation to the voice data input.

In a related embodiment, the ontology processing block comprises a database storing the corrected data file and a server adapted to run an ontology application referencing an ontology in relation to the corrected data file and generating the standardized output in a form accessible to an external system.

The ontology may take many forms but in one embodiment comprises healthcare related billing codes.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIG. 1 is a broad conceptual illustration of the invention;

FIG. 2 is a flowchart illustrating an exemplary method of developing an ontology;

FIG. 3 flowchart further illustrating an exemplary method of identifying concepts within the context of an ontology development;

FIG. 4 is a conceptual system description illustrating one embodiment of the invention in some additional detail;

FIG. 5 is a flowchart illustrating an exemplary data flow through an embodiment of the invention like the one described in relation to FIG. 4;

FIG. 6 is a conceptual diagram further illustrating another embodiment of the invention in which a corrected data file is applied to multiple ontologies;

FIG. 7 is a flowchart illustrating one exemplary method of use for the invention in the context of a medical patient evaluation; and,

FIG. 8 is a diagram further illustrating the incorporation of a control grammar and/or grouped data elements in one embodiment of a syntax processing block according to the invention.

### DESCRIPTION OF THE EXEMPLARY EMBODIMENTS

The invention addresses the general need for a healthcare related system adapted to capture non-standard input data and generate a standardized output in relation to the non-standard input data. The standardized output is generated by reference to an ontology adapted to extract and/or define knowledge (e.g., semantic content) from a data file that accurately expresses the subject matter of the non-standard input data. Modification, processing, and/or synthesis of the non-standard input data is broadly termed “correction”, and thus the data file accurately expressing the subject matter of the non-standard input data is termed a “corrected data file.”

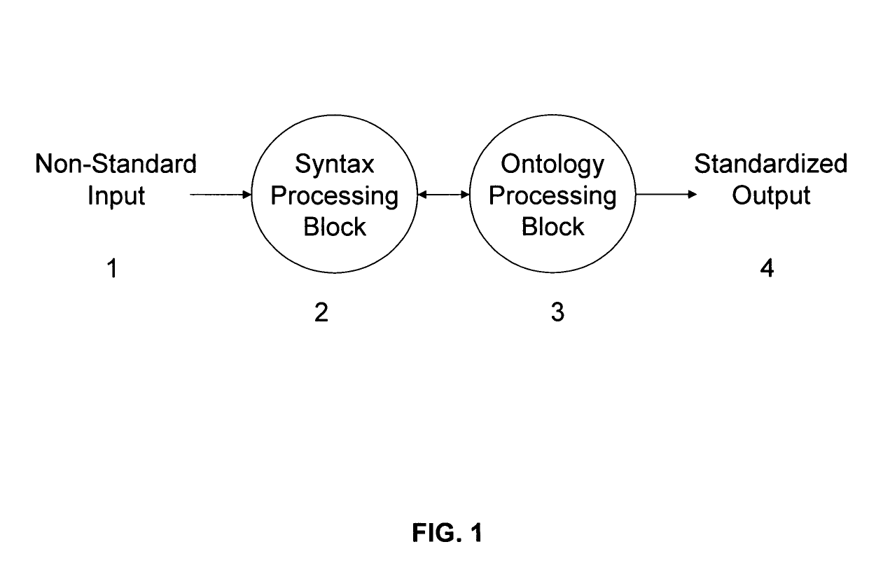

One embodiment of the invention is conceptually illustrated in FIG. 1. As shown in FIG. 1, the invention generally comprises a syntax processing block 2 receiving a non-standard data input 1, and generating a corrected data file which serves as an input to one or more ontology processing block 3. Ontology processing block 3 generates a standardized output 4 in relation to the corrected data.

Hence, one embodiment of the invention comprises two principal blocks; the syntax processing block and the ontology processing block. In this context, the term “block” has reference to an arbitrary conceptual distinction made between functional aspects of the invention. It should not be read as necessarily defining a hardware/software partition or a partition between two separate hardware platforms or sub-systems. Indeed, the syntax processing block and the ontology processing block may be implemented using a common or separate hardware/software platform(s). This having been said, at least one embodiment of the invention recognizes certain benefits associated with the implementation of the syntax processing block and ontology processing block in separate platforms.

As used above, the term “processing” should be read to broadly cover any combination of hardware and/or software functionality capable of implementing the data manipulation, transfer or conversion operations, as well as any logical, mathematical, or access operations necessary to accomplish the design of either principal processing block. Signal and/or data processing may in some embodiments be accomplished by a “digital logic platform” including, for example, a microprocessor, a digital logic unit or processor, a micro-controller, a programmed logic array, a state machine, or similar computational hardware and associated memory (hereafter these conventional elements are generally referred to separately and/or collectively as “computational logic and memory”). Several examples of possible digital logic platforms will be described in some additional detail hereafter.

Regardless of the specific nature of the digital hardware platform, it will run one or more applications enabling aspects, features, or functionality associated with embodiments of the invention. The term “run” is used in the broad context normally associated with software execution on a hardware platform. An “application” is any portion of software code enabling at least one function. A “subroutine” is generally used to describe some portion of software code less than an application, but those of ordinary skill in the art will understand that any body of software may be arbitrarily partitioned in many ways to produce multiple applications, multiple subroutines, and/or multiple applications each having multiple subroutines. Nonetheless, reasonable effort has been expended here to describe the exemplary embodiments coherently. So, terms such as “application” and “subroutine” have been used to illustrate possible relationships, but in the end its all “software” subject to great variation in design and implementation.

The syntax processing block performs at least one function; it generates a corrected data file in relation to the non-standard input data. “Non-standard input data” is any information bearing data potentially subject to ambiguity, misrepresentation, omission, or error in its use, interpretation, or expression. Audio data, text data (printed or handwritten), electronic file data (independent of storage medium), and/or image data are ready examples of non-standard input data. One or more of these different kinds of input data may be contained in a single “data file.”

Consider the example of voice data (i.e., human speech)—a common form of non-standard data. Naturally spoken voice data is classically non-standard. Different speakers express identical information using different words, phrases, tone, pitch, timing, syllable emphasis, and accent. For example, one healthcare practitioner may say “hypertension”, whereas another might say “elevated blood pressure”.

Text data is similarly non-standard in its use and expression. Nowhere is this more obvious than in the context of handwriting which is notoriously non-standard. However, even printed text data comes in a variety of fonts, sizes, and print quality. Anyone who has ever tried to read a copy of a copy of a copy understands the problems associated with non-standard text data. Even where handwritten or printed text data is clear and legible, it often includes non-standard expressions. Consider the common prevalence of misspellings, punctuation and grammar errors, formatting and typographical errors. All of the foregoing combine to make text data non-standard in its use and/or expression.

Visual or image data is frequently more non-standard than either audio data or text data. Video data (regardless of format), still pictures (black and white, color, film, or digital), and scanned images (e.g., x-rays, MR images, ultrasound images, etc.) are all prone to distortion, bad lighting, errant focus, incorrect views/angles, fading, jitter, hue and chrominance errors, and/or polarization effects, etc.

The foregoing are but a few of examples of non-standard input data. Regardless of its specific form, the non-standard use and/or expression of data often obscures the information contained in the data. The noted difficulties in organizing and accessing the increasing wealth of information generated by our society is directly related to the great variety of non-standard uses and expressions that characterize the data.

Accordingly, the syntax processing block of the invention receives or accepts non-standard input data and corrects for one or more types of non-standard use or expression to generate a “corrected data file.” A “data file” in this context may be any form of data susceptible to storage, transfer, and/or access. The particular type of storage medium and/or access technology may vary widely. In a related aspect, the corrected data file may be generated in a form that enables a logical or indexed search of the data file. However, this need not be the case, so long as the data contained in the data file is syntactically correct according to a predefined syntactical specification.

In this regard, the word “syntax” as used in the term “syntax processing block” should not be read in only the limited context of a grammar—like those associated with a language, whether human or computer. Rather, syntax should be broadly read as describing a connected or orderly system, a set of relationships, and/or a harmonious arrangement of components or elements. Such “components or elements” may include, for example, symbols, words, phrases, relationships, concepts, visual images, and expressions. Thus, the practical process of syntactically correcting non-standard input data may take a variety of different forms.

In the context of voice data, an example of syntax correction may include application of speech recognition techniques, such as parsing, pattern or context interpretation, specialized word or phrase recognition, natural language processing, grammar and linking determinations, statistical analysis, semantic relationship analysis, and/or probabilistic modeling of lexical semantics.

In the context of text data, syntax correction may include application of handwriting recognition techniques, such as line definition, character boundary definition, segmentation, and/or parsing, trait analysis and inventory, geometric, and/or stochastic stroke or point modeling. Syntax correction of text data may also include spelling and grammar correction, sentence and paragraph parsing, and concept extraction.

Similarly, syntax correction of image data may include application of image correction and enhancement techniques, such as position correction, skew correction, gradient generation, image interpolation, image component extraction, enlargement or reduction, hue and chrominance adjustment, pixilation, statistical analysis, etc.

Syntax correction of electronic files may include application of data processing techniques, such as file conversion, formatting, parsing, data or concept extraction or linking, word or context analysis, statistical analysis, etc.

Syntax correction will most commonly be made in embodiments of the invention by means of various applications and/or subroutines running on a digital logic platform.

Syntax correction in the context of a healthcare record may include reference to one or more lexicon(s) of medical terms. That is, the great plurality of specialty words and phrases used in various healthcare professions may be properly included in a data file, and a voice input data generated data in particular, using one or more medical lexicons.

In the context of the syntax processing block, syntax correction may include more than one form or manner of correction. Indeed, syntax correction is not limited to only the application of techniques designed to improve the quality of constituent data components (e.g., words and phrases). For later reference purposes, this form of correction is termed “component-correction,” and is understood to encompass a broad range of data component correction techniques, such as those applied to digital data, alphanumeric characters, words or phrase, image components, or textual errors, etc.

Additionally or alternatively, non-standard input data may be corrected as a larger body of data (e.g., groups including multiple components) or in a conceptual context according some defined criteria. Hereafter, this form of correction is termed “criteria-correction.” For example, criteria-correction may implicate an accounting or quality control mechanism assuring that data is complete or properly defined as a body of information. Thus, a building inspector providing non-standard input data to a syntax processing block according to the invention might be required to include data regarding the electrical, plumbing, and mechanical systems of the building being inspected. Any attempt by the inspector to conclude the inspection and generate a documenting data file without fully addressing all three system types would result in an error message by the system indicting an “incorrect” data file. Thereafter, the inspector would be able to either properly complete the inspection or specifically note an exception to the criteria requirement. In this manner, the corrected data file resulting from the inspector's work is defined in accordance with a criteria mandating information of a certain type, character, or quality.

Data authentication, verification, audit marking, or similar security mechanisms are ready examples of potential criteria used for criteria-correction. Thus, in one embodiment, a data file is not acceptable as a syntax processing block output until it has been properly designated for authenticity with an authorship identifier, a digital signature, etc. In another embodiment, a data file is not acceptable as a syntax processing block output until it has been associated with a security key, such as an encryption/decryption key. In these and other selected embodiments of the invention, the syntax processing block will issue a correction demand or otherwise note non-compliance with a mandated criteria until such time as it receives the mandated input data.

The ontology processing block in the foregoing embodiments performs at least one function; it generates a standardized output in relation to the corrected data file. The manner in which a corrected data file references an ontology within the ontology processing block to generate the standardized output is defined in large measure by the nature and content of the underlying ontology.

An “ontology” in the context of the invention has a meaning distinct from that associated with this term as it is used in field of philosophical metaphysics. Rather, the term is used here in the context of knowledge representation. In one context applicable to the invention, the term may be construed to mean a conceptualization specification. That is, an ontology is a description of concepts and relationships that may exist for specific components or elements, or between a collection of components and elements.

In one embodiment of the invention, the conceptualization specification is defined by an ontology forming a hierarchy of related concepts. This hierarchy (e.g., a tree structure) is initially formed by linking concepts together in simple (lower order) “IS_A” relationships to create a taxonomy. Yet, an ontology within the meaning of the invention is more than a taxonomy, a simple classification of vocabulary components, or an index to vocabulary components. Although a taxonomy contributes to the semantics of the respective components, an ontology defines a richer set of relationships between each component and one or more other concepts. It is these rich (higher order) relationships that enable the expression of domain-specific knowledge, without the requirement of necessarily including domain-specific concepts. Accordingly, an ontology is always associated with a subject matter domain.

An ontology formed in accordance with the foregoing is particularly well-suited to share a common understanding of the structure of information contained in a corrected data file. This communication of a common understanding may occur between agents of any (and/or differing) types, including information systems and human users. Hence, the ontology enables embodiments of the invention to be hardware agnostic.

An ontology also enables the efficient reuse of stored domain knowledge. It allows domain assumptions to be explicitly stated and/or negotiated. It allows domain knowledge to be separated from collateral or operational knowledge. Hence, the body of stored domain knowledge may be significantly reduced in volume. Finally, the ontology allows a domain to be efficiently analyzed. Formal analysis of components is extremely valuable when both attempting to reuse existing ontologies or extending them.

It should be noted in this context that building a domain-competent ontology is not the end goal of the invention, although the utility and efficiency of the various embodiments of the invention will be derived in large measure from the quality of the ontology implicated in an ontology processing block. Thus, in one related aspect of the invention, ontology development may be considered a process of defining data and data structures (i.e., components) to be accessed by an external agent. To better understand how this is accomplished, the process of ontology development should be described in the context of one or more embodiments.

Ontology development is inherently specific. There is no one correct method of developing an ontology. There are always viable alternatives and the best solution almost always depends on the ontology's application and its contemplated extensions. This having been said, practical ontology development is necessarily an iterative process. Generally, a rough first pass is made, and thereafter the ontology is sequentially defined and refined through actual use, testing, and refinement modeling. Additionally, the concepts in an ontology should be closely related to objects (physical or logical) and/or relationships associated within the selected domain. Where words or phrases are used as ontology components to describe concepts, for example, nouns will most likely define objects and verbs will most likely define relationships.

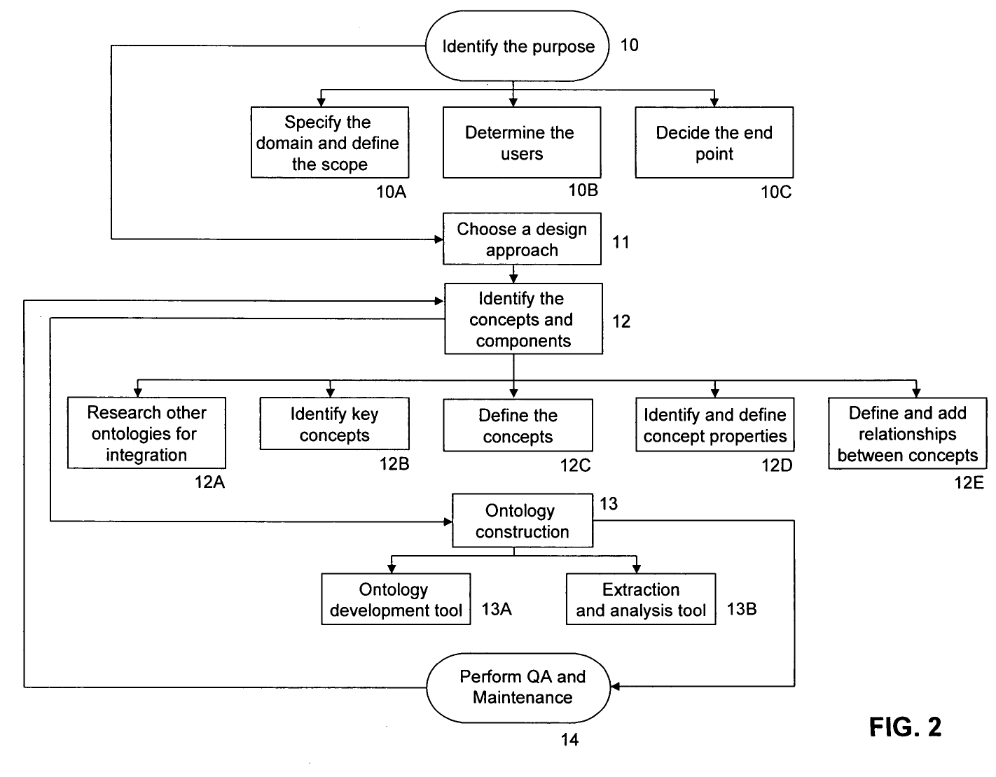

With the foregoing cautions and general commentary in mind, the flowchart shown in FIG. 2 illustrates one embodiment of a method adapted to the development of an ontology.

The exemplary flowchart shown in FIG. 2 comprises five (5) general steps, including; identifying the ontology's purpose (10), choosing a design approach for the ontology (11), identifying concepts, components and conventions (12), constructing the ontology (13), and maintaining the ontology (14).

Before creation of an ontology begins, it is essential to establish its intent, focus, and boundaries in the context of a solution to some knowledge-based problem or representation. An ontology's structure is driven by its purpose. Commonly occurring purposes include linking multiple vocabularies, standardizing concepts across a range of systems, providing a defined lexicon to drive a subsequent evaluation tool, aggregating or categorizing data across disparate systems, or supporting an expert system (i.e., a decision-making system).

In almost every case, definition of a clear purpose requires definition of a domain and its scope (10A), a determination of possible users (10B), and a decision on one or more end points (10C). Domain and domain scope definition may be performed in consultation with subject matter experts and/or interested parties, like customers or suppliers. The domain scope is integrally related to end point definition and user determination.

Once the ontology's purpose has been identified, a design approach decision follows (11). Clearly, no one design approach is better than another. Design approach is driven in great measure by the purpose, domain scope, and users contemplated for the ontology. It is, however, quite common to begin an ontology with the definition of a hierarchy. Thus, the type of hierarchy will often suggest a design approach. For example, a top-down approach may work well when general concepts are known, but more specialized and/or subordinated concepts need to be better defined. In contrast, a bottom-up approach may work well where a multiplicity of specific concepts require grouping or broader classification. Finally, a combination of these two general approaches may be used where obvious concepts are initially defined at multiple levels and additional related concepts, both broad and more specific, must be added thereafter.

Once a general design approach has been identified, the identification of concepts and components begins. This stage of ontology development typically requires the most “heavy-lifting.” To reduce the burden involved in the definition of concepts and components, it is generally advisable to research existing ontologies, vocabularies, taxonomies, etc. (concept aggregations) for insights or even outright incorporation within the ontology being developed (12A). Many ontologies/concept aggregations are available in electronic form and may be imported in whole or in part. In this regard, the format of expression for the other ontology is immaterial since it can usually be translated with relative ease prior to incorporation. There are, however, many considerations to the importation of an existing ontology or concept aggregation, including; the purpose, the fit or form-factor, its base language, import and export capabilities, graphical abilities, modeling features and limitations, its proprietary verses open-source nature, licensing requirements and costs, and extensibility.

Next key concepts are identified (12B) and defined (12C). Within the context of the ontology's domain, existing models, lexicons, and similar or related ontologies may be examined to identify key concepts. Here again, the use of existing subject matter decreases development costs and promotes semantic interoperability. Existing subject matter may be found in a variety of sources including websites, technical and trade journals, and research reports.

The inclusion or exclusion of concepts from the defined domain largely defines the ontology. Concept identification may be accomplished, for example, by use of a concept coverage study of a domain-specific corpus of information, including documents, electronic data files, textbooks, web pages, journal articles, etc. Parsing of the corpus may be done electronically, using for example a natural language processor and text extraction program followed (optionally) by manual review. Concepts identified by a concept coverage study may thereafter be compared to standards and existing lexicons, taxonomies, and/or ontologies.

Once identified, concepts are typically placed within a linkage model defined, by simple IS_A relationships. These simple relationships are driven by the identification of properties associated with the various concepts, as supported by information derived from the corpus of information, and additionally including input from one or more subject matter experts.

The identified concepts are next defined (10C). This can be a lengthy and troublesome process, since many strings (e.g., words) have multiple meanings across various contexts and even within a narrow context. For example, within a domain related to the medical evaluation of a patient, the term “COLD” may indicate a temperature, a physical sensation, mood or feeling, a commonly occurring viral infection, or Chronic Obstructive Lung Disease. Hence, conceptual definitions should provide a context that is consistent with the domain. Forming an appropriate definition will allow the ontology developer to determine which concepts can be merged based on the synonymy. Knowledge of the definition will also influence naming conventions.

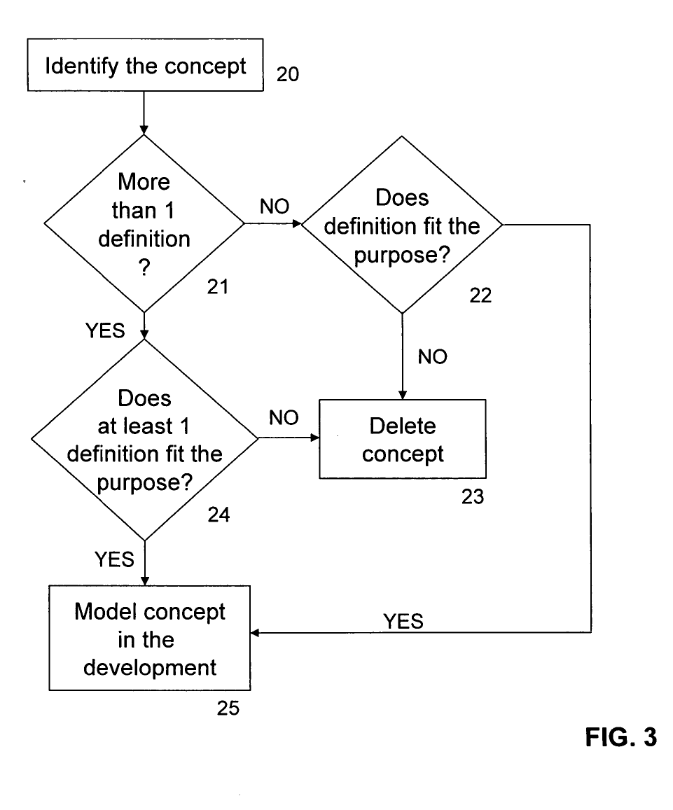

The flowchart of FIG. 3 illustrates an exemplary method for defining concepts within the development of an ontology. First, a concept is identified (20). The concept is examined to determine whether one or more definition exists (21). Where but a single definition exists (21=no), the definition is further examined to determined whether the definition fits the purpose of the ontology (22). Where the definition is unrelated to the purpose of the ontology (22=no), the concept is deleted from the ontology development environment. If, however, the single definition does fit within the purpose of the ontology (22=yes), it is modeled within the ontology development environment (25).

Returning to the first determination (21), where the concept has more than one definition (21=yes), the concept is further examined to determine if any one of the definitions fits the ontology purpose (24). If not (24=no), the concept is deleted (23). If, however, one or more of the concept definitions fits the ontology purpose (24=yes), the concept is modeled within the ontology development environment (25).

It should be noted that the logical placement of concepts within an ontology necessarily implies definition properties. Properties are domain and purpose specific, and define how data in the ontology is presented and structured. That is, the selection of properties and relationships to be included in the ontology is determined by the purpose and scope of the ontology, as well as the analysis of the domain. Exemplary properties for a given ontology concept include a corresponding definition and synonyms. The inclusion of synonyms is critical for semantic interoperability of the ontology. Similarly, an important goal for many ontologies is reuse, or the use of the ontology in applications other than the application for which the ontology was originally intended. An understanding of the concepts and the thought processes used in the development of the ontology is essential to the reuse of the ontology. As a result, the explicit textual definition of concepts increases the usefulness of the ontology.

In a similar vein, ontologies ideally provide a unique identifier for each concept. Unique identifiers in such embodiments should be context-free. Ideally, the unique identifier is searchable and automatically generated by the ontology building tool.

Relationships define possible or existing connections between concepts. Any reasonable number of relationships may exist in an ontology. The “IS_A” relationship is fundamental to any ontology, and is sometimes termed a parent-child relationship. The selection of other relationships beyond the IS_A relationship is a matter of design choice and will be driven by the intended purpose, scope and use of the ontology. An ontology should have more than just “IS_A” relationships. Generally, the inclusion of more relationships types results in a more semantically rich ontology. Other exemplary relationships include: “PART_OF”; “MAPS_TO”; and “INTERACTS_WITH”.

The establishment of conventions is not illustrated in the flowchart of FIG. 2, but is typically deemed necessary as part of either the identification phase (12) or the construction phase (13). Conventions are rules on how to build the ontology, and may be categorized as being one of two general types; modeling conventions and naming conventions. Exemplary modeling conventions may include such statements as: “all children have a parent”; “children have only one parent”; or “a concept may not be both a sibling and a parent to another concept”. Exemplary naming conventions may include such statements as: “all properties use lower camel case”; “all concepts use upper camel case”; and “words in multi-word concepts are connected with underscores”. The early agreement on and communication of conventions tends to increase the efficiency of the ontology development and minimize re-work.

With a purpose identified, a design approach selected, and concepts, relationships, components and conventions identified, the ontology is ready for construction. The practical mechanics for building an ontology will vary, but in one embodiment generally include selecting an appropriate ontology building tool (13A), and selecting an extraction/analysis tool (13B). Following these two selections, concepts and properties are added to the ontology using the development tool, a concept hierarchy is defined according to a set of IS_A relationships, and thereafter one or more relationships are added to the ontology beyond the IS_A relationship(s).

Selection of an appropriate ontology building tool should take into consideration many factors. First, the ontology building tool must be evaluated in the manner it provides for modeling concepts. Concept creation and addition techniques are an important consideration. Concept modeling should employ formal and informal techniques for capturing, manipulating and specifying relationships between concepts, and should allow organization of same within a hierarchical structure. The development tool should allow for concept mapping, i.e., the process of identifying the concept or concept group closest in meaning relative to one or more vocabularies. The development tool should also have the ability to link synonymous concepts between vocabularies in a concept matching process. The development tool should further provide an efficient mechanism for navigating the ontology hierarchy, thereby allowing the developer to see where certain concepts currently reside within in the hierarchy or where certain concepts are missing from the hierarchy.

The development tool should also allow the ontology to be effectively queried. For example, concepts should be selectable on the basis of similar criteria, according to multiple definitions, or according to when or who edited them. Merged concepts, recently added concepts, source concepts, and target concepts should be readily queried.

The process of selecting an ontology development tool (13A) is routinely, but not necessarily, accompanied by the selection of an extraction and analysis tool (13B) which may be applied to the concepts arranged in the ontology. Iterative application of these and related tools ultimately yields the finished ontology.

Application of Quality Control (QC) and maintenance processes (14) ensure the initial development is adequate and safeguard the long-term usefulness of the ontology, respectively. The QC techniques applied to the ontology will vary according to design approach, but may include queries for adherence to rules and conventions; checks for orphan concepts (i.e., concepts that exist in the ontology but are not connected in the hierarchy); queries to identify and/or clarify ambiguous terms and homographs (e.g., concepts with identical strings); checks for multiple parents; and checks for circular or redundant concepts.

Since an ontology is never really complete because new concepts are always emerging, maintenance becomes an important ontology consideration. Exemplary ontology maintenance standards have been promulgated in ISO/TS 17117. At a minimum, an ontology should include version control, an audit trail and undergo regular reviews.

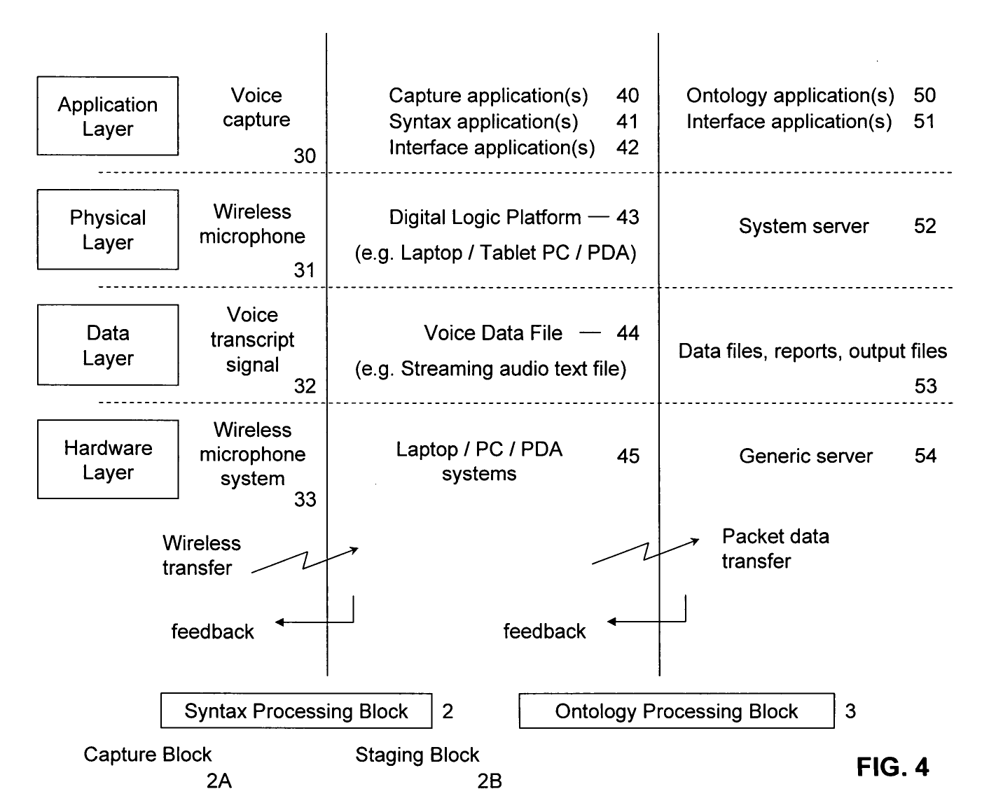

With the conceptual illustration of FIG. 1 and the foregoing discussion in mind, another more specific embodiment of the invention is illustrated in FIG. 4. The syntax processing block 2 of FIG. 4 is further described as comprising a capture block 2A and a staging block 2B. These functionally related blocks are further illustrated in various layers in the context of a working example.

The working example is described in reference to an embodiment of the invention adapted to a patient evaluation system. Within this particular system, choices regarding sub-system boundaries, and hardware/software types and partitions are made in the context of the working example and are merely exemplary. Different embodiments of the invention would almost certainly result in different design choices.

However, turning again to FIG. 4, the capture block comprises a wireless microphone system 33 as a hardware layer including a wireless microphone 31 physically associated with a system user (e.g., a healthcare practitioner). The wireless microphone system 33 comprises voice capturing software 30 in the application layer which allows generation of a voice transcript signal 32 in the data layer. In the context of working example, any type of conventional or custom microphone capture devices, such as Motorola BlueTooth® microphones, INTEC's “Lucy” microphone, or Vocera's voice-over-IP communications device may be used to implement a capture block. Regardless of specific hardware implementation, the voice transcript signal 32 is wirelessly communicated to the staging block 2B.

While certainly not required in the broadest implementations, wireless communication of a capture block generated data signal to an associated staging block is a noteworthy aspect of some embodiments of the invention. For example, a healthcare practitioner (e.g., a nurse, physician, or technician) often has his/her hands full with equipment or may require one or both hands during a procedure. Accordingly, a hands-free data capture capability would be highly beneficial. This is true of other potential system users including inspectors, maintenance personnel, researchers, and investigators.

Staging block 2B is adapted to perform any number of data capture syntax correction, and related processes—typically through the execution of corresponding capture application(s), syntax application(s) and/or interface application(s). In the working example, a laptop or tablet Personal Computer (PC) or a Personal Digital Assistant (PDA) system 45 may be conveniently used as a digital logic platform implementing staging block 2B. This digital logic platform is located within communication range (e.g., in the same room or on the same building floor) of the wireless microphone 31 which forms the capture block's physical layer. Upon receiving the voice transcript signal 32 generated by the wireless microphone 31, the digital logic platform 43 runs a capture application 40 adapted to convert the voice transcript signal into a voice data file, such as a streaming audio file or text file 44 as defined by the data layer of the staging block 2B.

Appropriate interface applications 42 connect staging block 2B with capture block 2A and/or ontology processing block 3. For example, a signal processing, data decompression, and/or noise reduction application may be run in relation to the voice transcript signal before a voice data file is created by a capture application. Similarly, one or more interface applications 42 may packetize and encrypt the resulting corrected data file before initiating data packet transfer to the ontology processing block 3.

The syntax application(s) 41 operate on a non-standard, input data file between capture application 40 and an interface applications 42. In the context of the working example, any number of conventional or custom speech recognition applications may be used, such as IBM's ViaVoice® or ScanSoft's Dragon Dictate®. U.S. Pat. No. 6,292,771 further illustrates a collection of related processes adapted to convert a voice transcription signal into a grammatically proper data file having incorporated correctly used medical terminology. The subject matter of this application is hereby incorporated by reference. Additional examples of competent syntax applications adapted for use within a staging block of the invention will be discussed in some additional detail below.

By operation of the staging block 2B in cooperation with the capture block 2A, a corrected data file is generated in response to the non-standard voice data input by the healthcare practitioner. Once completed, this corrected data file is communicated to the ontology processing block 3. In the working example, the ontology processing block 3 may be remotely located (e.g., somewhere else in the hospital or in a separate facility located anywhere) from the staging block (2B). The data communication path may be implemented using a wireless network (e.g., a WLAN, WMAN, or ad-hoc (802.11 or Bluetooth) network), a hardwire connected (e.g., an Ethernet) link, or even the World Wide Web. In one related aspect, communication of the corrected data file is facilitated using conventional data packet communication and/or encryption techniques.

A system server 52 forms the physical layer of ontology processing block 3 and may be implemented using one or more conventional severs and associated equipment 54. Data files related to an ontology 53, as well as output data files, related reports, and/or bulk digital data files storing received corrected data files may be stored in a database, such as those manufactured by MySQL or Oracle, or in the file system of the operating system or in any persistent data storage, associated with the system server 52. Again, competent interface applications 51 allow the transfer, storage, and consumption of corrected data files within the ontology processing block 3.

One or more ontologies and related ontology application(s) 50 in the application layer form the heart of ontology processing block 3. In some embodiments of the invention, the ontology will be coupled with a Natural Language Processing (NLP) application, a Natural Language Understanding (NLU) application, or similar computational linguistics application. Alternatively, language processing capability may be incorporated in the syntax processing block. NLP applications and their like are conventional and generally apply computational models to better understand and characterize natural language. Such applications are particularly valuable where a free-form human voice input is expected to interface with a digital logic system.

An optional, but potentially valuable aspect of the invention is indicated by the separate feedback arrows shown in FIG. 4. The invention contemplates continual incremental improvements in the cooperation between capture block 2A and staging block 2B, and between syntax processing block 2 and ontology processing block 3. Feedback from staging block 2B to capture block 2A may take the form of visual user feedback (e.g., grouped data elements), whereby the healthcare practitioner sees on a visual display the results or system reaction to his/her voice input. This type of feedback is particularly important where the voice data is subject to criteria correction by the staging block 2B.

Feedback from ontology processing block 3 to syntax processing block 2 may take many forms including packet data transmission statistics, data file errors, or “learning” or context information indicating correction refinement or adjustments.

The embodiment shown in FIG. 4 is intended to be hardware independent, but several benefits are apparent from the working example. First, separate hardware platforms may be used to respectively implement the syntax processing block and the ontology processing blocks. The syntax processing block which in the embodiment comprises the capture block is relatively cheap, small, highly mobile. Thus, multiple syntax processing blocks may be efficiently used in relation to one ontology processing block which is relatively larger and more expensive. The ontology processing block may be located in a secure facility away from patients and healthcare practitioners (e.g., in a building-wide or regional server).

Conventionally available hardwired and wireless networks provide adequate data security and authentication protocols and mechanisms. Accordingly, data integrity may be ensured at minimum cost.

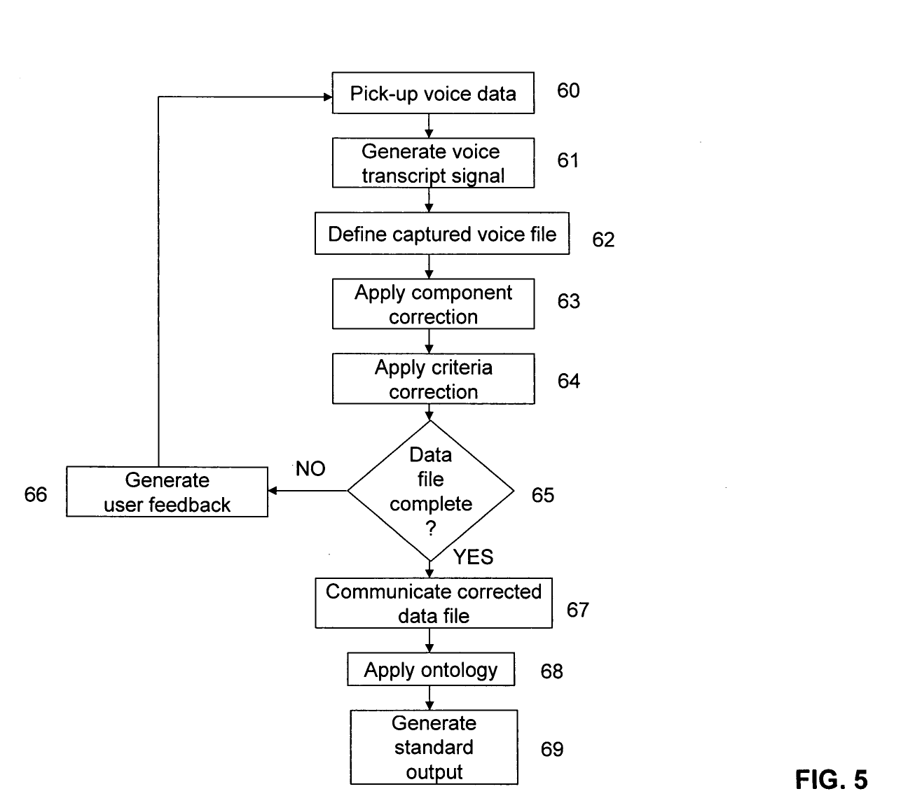

The flowchart shown in FIG. 5 further illustrates an exemplary flow of data through the system described in relation to FIG. 4. The data flow begins with a healthcare practitioner speaking freely as he/she conducts a patient evaluation. From this flow of non-standard voice data, the exemplary system will ultimately generate a standardized billing report accurately defining billing codes from the substance of the patient evaluation. As the healthcare practitioner speaks, a wireless microphone picks-up the voice data (60) and generates a corresponding voice transcript signal (61). The voice transcript signal is communicated to the staging block where it is captured in a voice file (e.g., streaming audio or a text file) (62). The combination of wireless microphone and speech recognition application running in the laptop or tablet PC may be conventional. Alternatively, conventional speech recognition software may be customized via the incorporation of a healthcare-specific lexicon. That is, words and phrases normally occurring in routine conversation are processed using the conventional speech recognition application. However, where an esoteric health term or phrase is used by the healthcare practitioner, the lexicon is queried to determine the appropriate word or phrase. The use of an appropriate application to provide access to a lexicon is an excellent example of component-correction (63). That is, the selected words (i.e., components) forming a portion of the non-standard input data are correctly interpreted and defined within a corresponding data file.

At this point it should be noted that the syntax processing block may utilize an ontology of its own. Here, for example, health terms may not only be properly interpreted from the voice input data, but also associated with supplemental information derived from one or more related ontologies.

Following component correction (63), the captured voice file (now called a “data file”) may be additionally (and optionally) subjected to criteria correction (64). Where the resulting data file is not complete (65=no), feedback is generated (66) and communicated to the system user (e.g., a visual indication on the laptop PC, and/or an audio error indication). Thereafter, the user may enter additional voice data to correct the indicated problem until the data file is complete or an exception is duly noted. In this example, the patient evaluation may include certain minimal global criteria or criteria specially mandated as a result of the ongoing or previous evaluations.

Once the corrected data file is component corrected and complete as to all relevant criteria (65=yes), it is communicated to the ontology processing block (67).

Ontologies by their very nature are highly susceptible to errors resulting from erroneous inputs. That is, the concepts and relationships defining the ontology are defined in relation to input components (e.g., vocabulary terms). Accordingly, errant input components are highly likely to produce errant ontology outputs. By correcting a data file in relation to components and/or criteria, the benefits offered by the ontology are maximized.

For example, healthcare billing codes are notoriously numerous, subtle in their distinction, yet highly important for accurate financial compensation. An ontology correlating patient evaluation data with billing code data is, thus, dependent on the accuracy of the patient evaluation data. Hence, the significance of the syntax processing block between the non-standard voice input and front end of the ontology.

By applying the ontology (68) to a properly corrected data file, an accurate standardized output (e.g., billing codes) may be generated.

Within the invention, the ontology forms at least part of a reference knowledge base. This reference knowledge base need only span the scope of the relevant domain. However, multiple ontologies may be applied to a single corrected data file in order to produce multiple standard outputs. In this manner, respective ontologies may be efficiently developed and maintained in relation to a properly scoped domain.

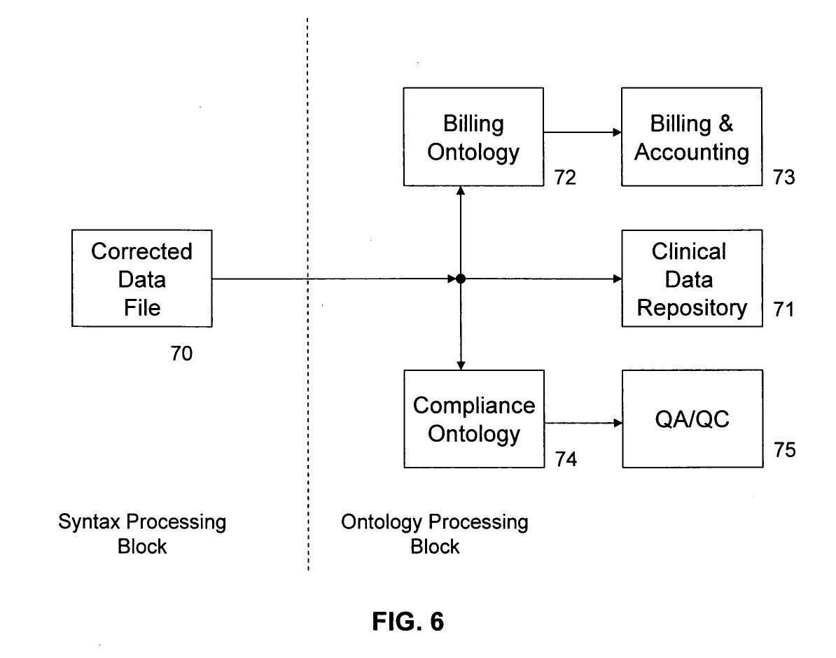

For example, consider the data flow shown in FIG. 6. A corrected data file 70 is communicated from a syntax processing block to an ontology processing block having multiple ontologies. Upon receipt in the ontology processing block, the corrected data file may be stored without further data processing in a clinical data repository 71 for future reference. The corrected data file is also passed to billing ontology 72 and compliance ontology 74. Billing ontology 72 extracts a proper set of billing codes and/or internal accounting codes from the subject matter of the corrected data file and generates a standardized billing report which may thereafter be sent to an accounting records file. Compliance ontology 74 examines, for example, the time spent with the patient in relation to a number of factors including the diagnosis, the nature of the patient, the healthcare practitioner's relative experience, etc., in order to generate a standardized Quality Assurance (QA)/Quality Control (QC) report.

Thus, a single corrected data file may be used as input data to multiple ontologies. Each ontology may generate a different standardized output. Alternatively, a sequence of ontologies may be cascaded to sequentially generate standardized outputs. For example, the billing codes produced by billing ontology 72 might be applied to a financial QA/QC ontology designed to examine billing statistics and trends.

The term “standardized output” has been used to describe the output of an ontology application implemented in the ontology processing block. This term should be read as encompassing any output form acceptable to an external system, whether human or machine. For example, nearly every profession and industry defines certain data standards or protocols. In the context of the healthcare application discussed as a working example thus far, there are many standards that might serve to define the exact nature and content of the system's output, including standards established by the Health Insurance Portability & Accountability Act (HIPAA), Systematized Nomenclature of Medicine—Clinical Terms (SNOMED CT), International Classification of Diseases: 9^{th} revision, Clinical Modification (ICD-9-CM), Current Procedural Terminology (CPT), Health Level 7 (HL7), Digital Imaging and Communications in Medicine (DICOM), Food & Drug Administration (FDA), Veterans Affairs (VA), National Library of Medicine (NLM), and the World Health Organization (WHO), etc.

There are many fields of endeavor wherein embodiments of the invention might find beneficial application, and most of these fields have numerous standards—many of which are government mandated. For example, inspections (e.g., building, insurance, home, utilities, and social services), accounting audits, investigations (e.g., fire, police, medical and insurance), and maintenance (e.g., aircraft and shipping) are ready examples of fields of endeavor in which non-standard data must ultimately be converted into a standardized output (e.g., a report).

The same can be said for other fields of endeavor that while less regulated by government or industry mandated standards, nevertheless benefit greatly from adherence to an agreed upon standard. Consider for example such fields as research (e.g. legal, scientific, or academic) and customer self-service.

The term “standard” or “standardized” in the foregoing context may have reference to either the content and/or the form factor of the resulting output. That is, in the context of the working example, the standardized output might not only include properly identified and related billing codes, but also be presented in a form ready for immediate consumption by downstream systems (e.g., be interface ready via HL7 or XML, etc.).

It has previously been noted that powerful embodiments of the invention may be implemented using a non-standard voice data input coupled with a speech recognition application. In a further refinement of this particular aspect, the invention contemplates the additional provision of voice actuated control over the manner of data input. In one related embodiment, voice actuated control may be implemented using a control grammar. The control grammar is likely to be specific to the domain or knowledge encompassed by capture and/or syntax applications running on the staging block. Control grammar implementation may even be accomplished by a separate application running on the staging block hardware platform.

In this context and throughout this disclosure, it should be noted that various application types (e.g., interface, syntax, capture, etc.) are merely arbitrary distinctions used to identify certain common functionality found in the exemplary embodiments. Those of ordinary skill in the art will recognize that a single omnibus application might implement all software functionality in the syntax processing block and/or the ontology processing block. This is, however, unlikely for practical reasons. Nonetheless, no partition boundaries between various software implemented functionalities is intended by the descriptive references to one or more applications.

Thus, in the embodiment being described, the control grammar is linked to software subroutines enabling navigation of one or more enabling applications without a requirement for the use of traditional input devices, such as keyboard entries, mouse/menu selections, etc. While such traditional input are certainly enabled in the invention, the grammar control embodiment seeks to preserve the option of completely hands-free operation of the system.

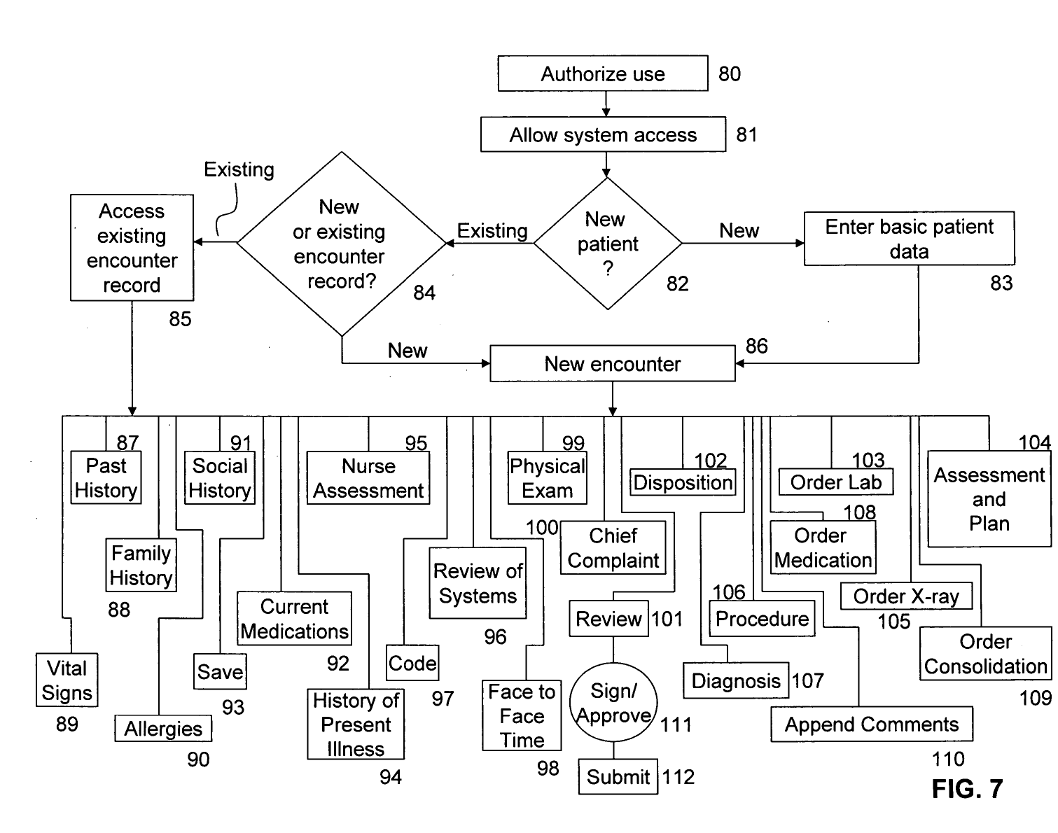

For example, consider the exemplary patient evaluation illustrated by the flowchart shown in FIG. 7. A system such as the one previously described is assumed in this example. A first healthcare practitioner (e.g., a nurse) begins a patient evaluation by speaking a system use authorization command word or phrase into his/her wireless microphone (80). (Hereafter, the term “command word” will be used to mean both single words and short command phrases). This command word might be as simple as, “BEGIN”, or might require a more extensive expression, “THIS IS NURSE JANE DOE, AUTHORIZATION CODE 12345.” Voice recognition software in the staging block allows access to the system in response to a properly given authorization command word (81). Alternatively or additionally, biometrics or simple passwords might be used to control access to the system.

Next, the nurse speaks one of two command words, “NEW PATIENT” or “EXISTING PATIENT” (82). If the new patient command is given, the system responds by creating a new record and (optionally) displaying grouped data elements for the new record on a PDA (or other the staging block-associated display) in the examination room.

The term “grouped data elements” is used to describe any visual user feedback mechanism designed to aid the user in the entry of data. In one embodiment, grouped data elements may resemble a data entry template or form visually communicating to a user which data fields have already been addressed. However, the optional use of grouped data elements as a visual feedback mechanism in the invention should not be construed as a requirement by the invention to “lock-in” data entry to a predefined form or sequence. Indeed, embodiments of the invention are designed to provide complete freedom of data entry, and a nurse or physician may navigate the data entry options (and optionally associated grouped data elements) at will, and in a non-linear fashion. Thus, while certain grouped data elements may be used to conveniently facilitate the organized retrieval, review and/or entry of data, they do not constrain the system user to a particular flow of data entry or sequence in patient evaluation. For example, a healthcare practitioner could detail a patient's vitals signs, immediately proceed to an Assessment and Plan, instantly navigate back to a Review of Systems, etc. without having to re-orient the application. The control grammar functionality within the Syntax Processing Block differentiates between commands, scalar values, and paragraph-based prose, and allows for non-sequential navigation.

Returning to the flowchart of FIG. 7, for example, grouped data elements corresponding to basic patient data (e.g., name, age, address, health insurance, etc.) may be displayed to aid the nurse in proper creation of a new patient record (83). Of course, it is not required that a nurse enter the basic patient data or initiate a new patient record. A receptionist or even the patient may be given limited access to the system to manually and/or verbally enter this data.

Existing patients fall into one of two categories; those with an exiting (current) encounter record (84=existing) and those requiring initiation of a new encounter record (84=new). This distinction is required since embodiments of the invention contemplate multiple healthcare practitioners accessing a common patient encounter record. Thus, a first healthcare practitioner seeing the patient will indicate a “new encounter” and a corresponding new encounter record will be formed in response to appropriate command words (86). Second and subsequent healthcare practitioners seeing the patient during an encounter will indicate “an existing encounter record” (e.g., by number or patient name) using an appropriate command word, whereupon the system will call-up the existing encounter record (85).

With an encounter record properly called-up, the healthcare practitioner is ready to begin a free-form patient evaluation. The multiple parallel paths illustrated in the flowchart of FIG. 7 are merely a selected collection of examples. Any number of patient evaluation options may be included consistent with the scope of the medical practice, patient type, etc. Further, as previously indicated, the patient evaluation options provided by a system may be traversed in any manner, with or without the aid of a control grammar and/or grouped data elements.

However, continuing with the working example, the nurse preferably performs a nurse assessment (95) which may or may not include; taking a patient history (past 87, family 88, or social 89), querying the patient on allergies (90) and/or current medications (92). The nurse assessment may include taking the patient's vital signs (89), discussing the patient's chief complaint (100), and/or discussing the history of the present illness (94). Each one of these general patient evaluation options may be independently undertaken in response to a spoken command word or manual data input. Within each option, free-form text may be input to one or more text box(es) associated with a grouped data element displayed in response to the command word or manual data input.

At some point following the completion of his/her assessment, the nurse may indicate face-to-face time spent with the patient (94), and then will save the accumulated patient evaluation data (93).

Once the nurse has completed his/her portion of the patient evaluation, a second healthcare practitioner (e.g., a physician) may continue the evaluation. The second healthcare practitioner authorizes use of the system (80), is given access (81), and accesses the existing encounter record (84=existing and 85). Here again, the second healthcare practitioner's use of the system is largely if not entirely unconstrained in its flow. However, the system may also demand that certain criteria be addressed during the patient evaluation by one or more of the healthcare practitioners. For example, the second healthcare practitioner may be required at some point during his portion of the patient evaluation to review and/or approve the nurse assessment. The patient evaluation may require a redundant entry of critical data, such as allergies, current medications, etc.

Nonetheless, the second healthcare practitioner may conduct his/her patient evaluation with his/her unique flow, vocabulary style, and manner—so long as established criteria are ultimately addressed. During a second healthcare practitioner portion of the patient evaluation, the second healthcare practitioner may conduct a review of systems (96), perform a physical examination (99), state a diagnosis (107), summarize a disposition (102), prescribe or perform a procedure (106), or record an assessment and plan (104). The system also provides a healthcare practitioner with the ability to order medications (108), x-rays (105), labs (103), and additional consultations (109).

Following completion of his/her evaluation, the second healthcare practitioner may review the patient encounter record or some portion of it (101), approve (i.e., sign) it (111) and submit it (112). Either before or after the patient encounter record is approved and submitted, the second healthcare practitioner may code (97) the encounter record for billing purposes. Should a healthcare practitioner desire to add explanatory or corrective information to a submitted encounter record, a comments note may be appended to the encounter record (110).

While the system is preferably designed in many embodiments to provide maximum flexibility to a healthcare practitioner's evaluation style, it need not be only a passive data receiver. In addition to the optional use of command words, grouped data element feedback mechanisms, and criteria based correction mechanisms, the system may be designed to be interactive in real time with a user.

In response to key words or concepts extracted from the entry of patient evaluation data, the system may optionally suggest (or require) the collection of supplemental information regarding the patient. For example, if the patient complains of “being tired and thirsty all the time” during a nurse assessment, the system may prompt the nurse to inquire regarding a history of diabetes in the patient's family. The system may thereafter flag a consultation page in the patient's encounter record with a highlighted note of “POSSIBLE DIABETES” upon submission of the nurse's assessment. This highlighted note will be seen by the second healthcare practitioner as he/she begins his/her portion of the patient evaluation. Additionally, the indication of possible diabetes may be used by the syntax processing block to identify and/or further refine a lexicon of medical terminology likely to be used by a subsequent healthcare practitioner during his portion of the patient evaluation. (This is one example of feedback from the ontology processing block to the syntax processing block).

As noted above, the foregoing example may incorporate a voice enabled application incorporating a control grammar. The control grammar allows a system user to navigate a potentially complex series of tasks using only his or her voice. A hierarchy of command words (and possible synonyms) may be constructed to allow logical progression through a patient evaluation. For example, a sequence of specific vital signs may be obligatorily or optionally implicated once the command word “VITALS” is spoken (e.g., temperature, blood pressure, pulse, height, weight, etc.).

Indeed, any number of subordinated command word menus may be used during each option and phase of a patient evaluation. Certain critical command words, such as “allergies” and “current medications” may be designated for mandatory inclusion in all patient evaluations.

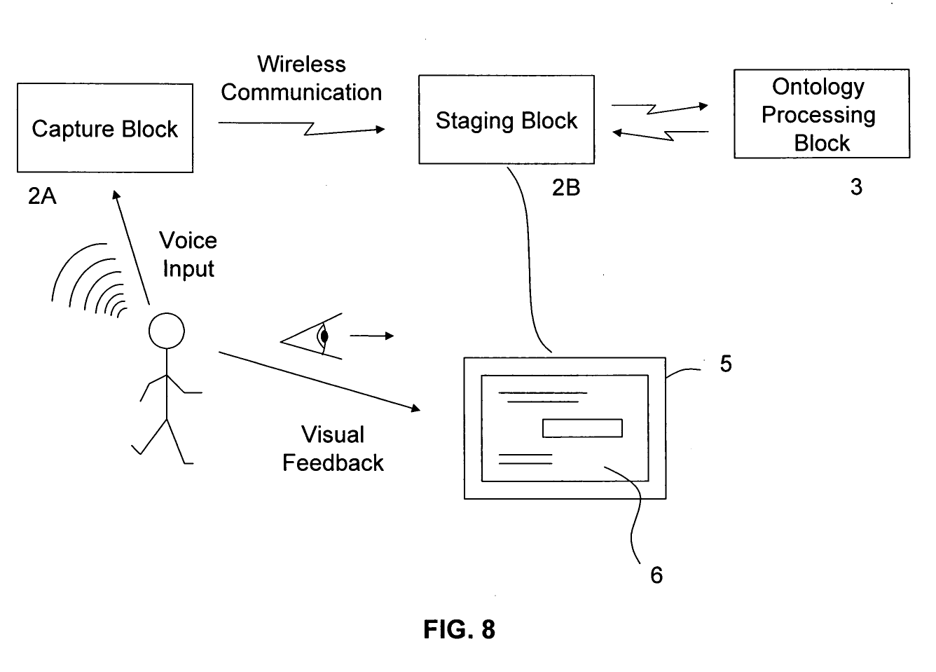

FIG. 8 further illustrates the use of a command grammar and grouped data elements feedback within an embodiment of the invention using a voice enabled application. A user's verbally communicates non-standard data to capture block 2A. Capture block 2A captures the non-standard input data, forms a voice transcript signal which is wirelessly communicated to staging block 2B. A control grammar application running on staging block 2B is responsive to command words extracted from the voice transcript signal or resulting voice data file to display grouped data elements 6 on the a display 5 associated with staging block 2B. Display 5 may be a wall mounted monitor, a the screen of a laptop or PDA, etc. The user is able to track his/her progress through a particular portion of the patient evaluation by looking at the grouped data elements on the display.

As indicated in the example above, the invention contemplates multiple users cooperating to develop a single corrected data file or multiple, related, corrected data files. For example, a plumbing inspector, an electrical inspector, and a structural inspector might access a common building inspection data file and enter data within their own specialty. In a similar vein, a healthcare practitioner might seamlessly access and complete a patient evaluation begun by an administrative assistant entering basic patient data and/or a nurse entering a nurse assessment.

The working example is drawn in part to the preparation of accurate billing codes corresponding to a patient evaluation. Thus, a complete, corrected data file is sent from the syntax processing block to the ontology processing block, where a competent ontology identifies all pertinent and/or possible billing codes corresponding to the patient evaluation. The billing codes may be communicated in real time to a healthcare practitioner's PDA for review and approval (e.g., digitally signing and ending the session). Alternatively, a summary of billing codes may be sent to the healthcare practitioner at the end of the day for his/her review and approval (i.e., a batch feedback mode as opposed to a real time feedback mode).

The standardized billing code output generated by the ontology processing block, as well as the corrected data file stored in a data base associated with the ontology processing block may thereafter be linked to various files (external or internal to the system). For example, laboratory results from laboratory tests order in the patient evaluation may be linked and correlated with the corrected data file stored in the system. Similarly, a patient scheduling application determining a follow-up visit or a pharmacy ordering application placing a prescription request may be automatically implicated as a result of the corrected data file's contents, and/or an ontology processing block response to the corrected data file.

The foregoing embodiments describing various aspects of the invention may further include various optional yet related features. For example, the system might allow a user to interrupt (halt and save) a patient evaluation before its completion, and thereafter allow the user to return to the point at which the evaluation was interrupted—without the loss of previously entered patient data.

In another aspect, the system is adapted to provide a complete audit trail of the entire patient evaluation or encounter. Audit information may include all data entries, work orders, and tasks performed for each healthcare practitioner by name, date, and/or system identification. Where multiple healthcare practitioners make data entries to a common patient record during an encounter, each entry is marked or associated with the entering practitioner. In certain circumstances, changes or additions to a patient record may require an accompanying explanation to satisfy the system's auditing mechanism.

While several embodiments described above emphasize the possibility of hands-free operation, it should be noted that voice-only data entry will rarely be a desirable design alternative. Some capability to input data using traditional data inputs techniques (e.g., mouse, keyboard, or stylus activated menu options) will almost always be desirable to accommodate different practitioner styles and/or patient sensitivities.

Various system user feedback options have been described above, whereby a user is given to understand that some essential criteria of the patient record has been omitted or entered in error. Such user alerts may be visual and/or audible. However, audible alerts should be capable of being turned off to appropriately match the working environment.

In another aspect of the invention, completed and “signed” patient records are saved within the system in a non-modifiable format, using such techniques as read-only access, encrypted master copies, etc. Subsequent access to such records will allow only the addition of comments or linking to another patient record.

In yet another aspect, the billing codes (e.g., Evaluation and Management “E&M” codes from the CPT standard) are preferably subject to mandatory review by an authorizing healthcare practitioner prior to completion and signing of a patient record. Further, changes to billing codes provided by the ontology processing block are noted as exceptions and preferably feedback to the ontology processing block as system learning information to be considered during ontology quality control and/or maintenance procedures.

In yet another aspect of the invention, multiple externally provided records may be appended or linked with a patient record, including images and schemas.

In the foregoing examples, the term “record” is used to describe the documentary results of a patient examination. This term is intended to be very broad and it encompasses much more than the subject matter of the traditional (hand-written) patient record. Any patient report or file might be considered a record for purposes of this description.

Indeed, the healthcare application variously described above as a teaching example is just that—an example. The invention is subject to much broader use and application. Several alternate applications have already been suggested above.

Additionally, however, the invention finds ready application in systems implementing Americans with Disability Act (ADA) section 508 accessibility options. Handicapped persons are better able to navigate complex system or software applications using embodiments of the invention. The combination of non-standard input data correction and ontology based knowledge access offers superior performance over conventional ADA accessibility methods.

Customer self-service centers would also benefit from embodiments of the invention. Customers would be able to more efficiently interact with service center applications without intervention by customer service personnel.

Site inspections have been identified above. Inspectors, engineers, social workers, and other professionals are enabled by embodiments of the invention to document details of an inspection or site visit in real time and in a manner consistent with governing regulatory bodies while at the same time keeping their hands free for work. Insurance claims adjusters, first responders like police, criminal investigators, firemen, and medical examiners would similarly benefit from the invention.

Aircraft and shipping inspectors would also be able to generate detailed, real time inspection reports in a manner required by government regulatory authorities while keeping their hands free to conduct physical examination of the plane or ship.

Researchers, be they legal, scientific, or academic would be able to use their hands to manipulate books, files, or physical investigative materials while at the same time generating a standardized output susceptible to further search, indexing, or input into an expert system.

Those of ordinary skill in the art will recognize that many modifications and adaptations may be made to the foregoing embodiments, and that the principles taught in relation to the invention may be applied to different fields of endeavor. In sum, the embodiments are examples. The scope of the invention is defined by the attached claims.

What is claimed:

1. A system, comprising:
a syntax processing block associated with a healthcare lexicon to receive non-standard input data and generate a corrected data file including components from the healthcare lexicon; and,
an ontology processing block to receive the corrected data file and generate a standardized output in response to the corrected data file.

2. The system of claim 1, wherein the non-standard input data comprises voice data, and the syntax processing block comprises a speech recognition application associated with the healthcare lexicon.

3. The system of claim 1, wherein the non-standard input data comprises handwriting, and the syntax processing block comprises a handwriting recognition application associated with the healthcare lexicon.

4. The system of claim 1, wherein the non-standard input data comprises text data, and the syntax processing block comprises a forms recognition application.

5. The system of claim 1, wherein the non-standard input data comprises image data, and the syntax processing block comprises an image recognition application.

6. The system of claim 1, wherein the non-standard input data comprises an electronic file, and the syntax processing block comprises a file parsing application.

7. The system of claim 1, wherein the non-standard input data comprises at least one of voice, handwriting, text, image data, and an electronic file, and wherein the syntax processing block comprises at least one of a voice recognition application, a forms recognition application, an image recognition application, and a file parsing application associated with the healthcare lexicon.

8. The system of claim 1, wherein the syntax processing block comprises a capture block wirelessly connected to a staging block.

9. The system of claim 8, wherein the capture block comprises a wireless microphone generating a voice transcript signal, and wherein the staging block comprises a digital logic platform receiving the voice transcript signal and generating the corrected data file in response to the voice transcript signal and with reference to the healthcare lexicon.

10. The system of claim 9, wherein the digital logic platform comprises; a Personal Computer (PC), a tablet PC, a laptop PC, or Personal Digital Assistant (PDA), or other transportable computing hardware.

11. The system of claim 9, wherein the digital logic platform comprises computational logic and memory adapted to run:
a capture application enabling receipt of the voice transcript signal and generation of a voice data file from the voice transcript signal;
a syntax application generating the corrected data file from the voice data file;
and with reference to the healthcare lexicon, an interface application enabling a data communication link between the syntax processing block and the ontology processing block.

12. The system of claim 11, wherein the data communication link between the syntax processing block and the ontology processing block comprises a Wireless Local Area Network (WLAN), a Wireless Metropolitan Area Network (WMAN), an ad-hoc wireless network, a hardwired Local Area Network (LAN), or an Ethernet connected network.

13. The system of claim 11, wherein the syntax application comprises a subroutine correcting components in the voice data file with reference to the healthcare lexicon.

14. The system of claim 11, wherein the syntax application comprises a subroutine correcting the voice data file in accordance with a criteria.

15. The system of claim 11, wherein the syntax application comprises one subroutine correcting components in the voice data file with reference to the healthcare lexicon and another subroutine correcting the voice data file in accordance with a criteria.

16. The system of claim 15, wherein the digital logic platform comprises a user feedback mechanism responsive to the syntax application.

17. The system of claim 16, wherein the user feedback mechanism comprises a display visually displaying grouped data elements.

18. The system of claim 17, wherein the ontology processing block comprises a database or other persistent data storage mechanism adapted to store the corrected data file received from the syntax processing block, and a server.

19. The system of claim 18, wherein the ontology is a healthcare related ontology and the server comprises computational logic and memory adapted to run an ontology application adapted to reference the ontology in relation to the corrected data file and generate the standardized output.

20. The system of claim 19, wherein the computational logic and memory are adapted to run an interface application enabling access to the standardized output by an external system.

21. The system of claim 20, wherein the ontology application is adapted to selectively reference one of a plurality of ontologies and generate multiple standardized outputs.

22. The system of claim 20, wherein the standardized output is standardized in relation to Health Insurance Portability &Accountability Act (HIPAA), Systematized Nomenclature of Medicine—Clinical Terms (SNOMED CT), International Classification of Diseases: 9^{th} revision, Clinical Modification (ICD-9-CM), Current Procedural Terminology (CPT), Health Level 7 (HL7), a Digital Imaging and Communications in Medicine (DICOM) standard, a Food & Drug Administration (FDA) standard, a Veterans Affairs (VA) standard, a National Library of Medicine (NLM) standard, or a World Health Organization (WHO) standard.

23. A system, comprising:
a syntax processing block comprising:
a wireless microphone system which receives non-standard voice input data from a user and generates a voice transcript signal in response to the non-standard voice input data;
a digital logic platform which wirelessly receives the voice transcript signal and generates a corrected data file with reference to a healthcare lexicon; and,
an ontology processing block which receives the corrected data file from the syntax processing block via a data communication link and generates a standardized output in response to the corrected data file.

24. The system of claim 23, wherein the digital logic platform comprises memory and computational logic adapted to run a syntax application generating the corrected data file from the voice data file with reference to the healthcare lexicon.

25. The system of claim 24, wherein the syntax application comprises a criteria-correction subroutine correcting the voice data file in accordance with a criteria defining content for the corrected data file.

26. The system of claim 25, wherein the criteria-correction subroutine implementing a voice activated, control grammar application controlling the receipt of voice input data and providing feedback to the user in relation to the voice data input.

27. The system of 26, wherein the syntax application further comprises a component-correction subroutine correcting components of the voice data file in relation to multiple healthcare lexicons.

28. The system of claim 27, wherein the ontology processing block comprises a database or other persistent data storage framework such as a file system storing the corrected data file and a server adapted to run an ontology application referencing an ontology in relation to the corrected data file and generating the standardized output in a form accessible to an external system;
wherein the ontology comprises healthcare related billing codes.

29. The system of claim 28, wherein the standardized output is standardized in relation to Health Insurance Portability &Accountability Act (HIPAA), Systematized Nomenclature of Medicine—Clinical Terms (SNOMED CT), International Classification of Diseases: 9^{th} revision, Clinical Modification (ICD-9-CM), Current Procedural Terminology (CPT), Health Level 7 (HL7), a Digital Imaging and Communications in Medicine (DICOM) standard, a Food & Drug Administration (FDA) standard, a Veterans Affairs (VA) standard, a National Library of Medicine (NLM) standard, or a World Health Organization (WHO) standard.

30. A system allowing hands-free entry of non-standard input data during a patient evaluation and generating a corresponding standardized output, comprising:
an ontology application running on a sever and referencing an ontology in relation to a corrected data file stored in database associated with the server; and,
a digital logic platform connected to the sever and generating the corrected data file in relation to the non-standard input data and with reference to a healthcare lexicon.

31. The system of claim 30, wherein the non-standard input data is component corrected in the digital logic platform with reference to the healthcare lexicon.

32. The system of claim 31, wherein the non-standard input data is further corrected in the digital logic platform in relation to a criteria.

33. The system of claim 32, wherein the non-standard input data is further corrected in the digital logic platform in relation to user input resulting from a set of grouped data elements visually communicated to the user on a display associated with the digital logic platform.

34. The system of claim 30, wherein the ontology comprises healthcare concepts, relationships, terminology, with an associated algorithm to produce billing codes referenced by the corrected data file.
